(19) United States
(12) Patent Application Publication
(10) Pub. No.: US 2010/0040999 A1
(43) Pub. Date: Feb. 18, 2010

(54) Education board game system and related method

(76) Inventors: Jennifer Culotta, Louisville, KY (US); Cynthia Young, Louisville, KY (US)

Correspondence Address: Valenti, Hanley & Robinson, PLLC, One Riverfront Plaza, 401 W. Main Street, Louisville, KY, 40202, US

(21) Appl. No.: 12/317,372

(22) Filed: Dec. 22, 2008

Related U.S. Application Data
(60) Provisional application No. 61/088,723, filed on Aug. 13, 2008.

(51) Int. Cl. G09B 19/22

(52) U.S. Cl. 434/128

(57) ABSTRACT

The invention provides an academic board game to assist in student education associated with a curriculum related to one or more players of the board game. The board game system includes a game board having a plurality of defined spaces that define a path of travel, a plurality of player tokens each representing a player and a player position on the path of travel traversed over the game board during play, a plurality of pre-defined playing cards having associated questions and answers, the pre-defined playing cards being color-coded according to subject matter, and a plurality of custom playing cards on which questions and answers directly related to at least one individual player's curriculum is placed. During play, the custom playing cards are used in part along with the pre-defined playing cards to determine player advancement on the game board.

### CROSS REFERENCE TO RELATED APPLICATIONS

This application claims priority to U.S. provisional patent application 61/088,723, filed Dec. 21, 2007, entitled “Education Board Game System And Related Method,” the entirety of which is incorporated herein by reference.

### BACKGROUND OF THE INVENTION

(a) Field of the Invention

The present invention relates generally to board games and in particular to promoting learning and advancing academic studies especially for primary and intermediate grades through use of board games.

(b) Background of the Related Art

A wide variety of board games directed to a wide variety of subjects and goals exist. Typically, board games are comprised of a playing surface, such as a planar, multi-sided board, on which, or adjacent to, playing pieces, playing cards, dice, and other objects are placed. Many board games contain sets or series of interconnected or logically related spaces on which players place and move respective playing pieces. Some games involve answering questions correctly and others involve applying rules to achieve an end goal, e.g., check-mate in chess. One or more players compete or at least participate in the game based on a set of rules and instructions provided with the game. Often games are directed to players having particular skill or knowledge level. For instance, games are often marked for adults, children, children and adults, and based on age groups or threshold age levels.

Games often test players' knowledge on one or more subjects as well as players' skill in navigating the board. There are numerous end or winning objectives, such as obtaining the most property or money, defeating opposing armies, being the first to answer a required set of questions, getting to an end location on the game board, or a combination of the above.

Some games are directed to particular themes, such as trivia, education, military, life, and business. While some games allow participants to use clay, draw with pencil and paper, and act out subjects, for example, the vast majority of games are essentially limited to a set of questions predetermined and delivered with the game by the game manufacturer. What is needed is a game system and method of using same that will provide the tools and allow participants to tailor questions and content based on individualized needs, such as grade level, actual school subjects, assignments and requirements, and anticipated actual school subjects, assignments, and requirements.

Therefore, it can be appreciated that there exists an unmet and continuing need for a new and improved educational board game system which can be used for educating students particularly in their area of study and for their particular level of education.

### SUMMARY OF THE INVENTION

An essential part of virtually all accepted school curricula is the requirement of independent study, outside the classroom, by primary, secondary, and intermediate students. The present invention provides a useful tool to promote studies, establish strong and effective study skills, and achieve academic success. To achieve this goal the game is structured to engage the player fully in the game processes and provide a high level of player enjoyment. The board game of the present invention provides an entertaining method to promote study that is conducive to general and specific academic success. More particularly, the board game is designed to reflect subjects of immediate interest to participants and is centered around grade level study reinforcement.

In one embodiment, the game focuses on two avenues of study through the playing cards. The first is “Review of National Core Content” and is included with the game as delivered to the recipients, purchasers or players. This comprises, for example, questions and concepts in six areas of study which are based on national core content curriculum for grades 4^{th}, 5^{th} and 6^{th}. In this manner, this aspect of the game provides a general base of study and knowledge to each student in those six topics of study. Of course, the particular areas included may vary or there may be a number of versions of the games made up of different subject configurations from which the user may select based on particular needs and interests or even regional or local curricula. For instance, the game may be “approved” as including and reinforcing curricula within a given school district or as set forth by a state governmental body, board of education, etc.

The second avenue of study included with this embodiment of the invention is the “Review of Individual Curriculum for a particular school.” This aspect of the game provides questions and concepts that are required for that individual's curriculum at their particular school. In one manner, these questions may be created by the student in advance of play—thus providing for a dual reinforcement of their particular areas of study, one being the drafting of the playing cards, the second being the actually review of the concepts through play. It should be appreciated that the game may be directly incorporated into school activities, where the students/players create questions during school for play during or after school. Also, the cards themselves may be used in or outside school to promote study separate from playing the game.

In one exemplary configuration, academic topics may include Arts and Humanities, Grammar, Language Arts, Math, Science and Social Studies. The subjects, as used in the game, may be color-coded for sight recognition. The difficulty of questions included with the game may range from simplistic to complex and are preferably age/level appropriate. The questions and concepts that appear on the enclosed playing cards are phrased in such a manner that all players, e.g., levels 4^{th}, 5^{th} and 6^{th}, can understand. The playing cards are color-coded and organized in sets designed to enhance academic study and focus on each players' individual core curriculum and academic level. The educational board game of the present invention emphasizes individual participation in the creation of the particularized study cards containing concepts or content specific to each individual student. Furthermore the additional blank playing cards (which may be color-coded as well) can be used to create personalized playing cards with the questions and concepts created on the blank playing cards reflecting those necessary for each individual player's academic success and related to the individual player. In addition, existing cards in the possession of the player, or teacher or parent, may be used alone of in combination with the other cards while playing the game.

In this embodiment, the present invention includes a board having a series of connected spaces about which players move playing pieces representing each player's progress. The players move along the spaces based on successfully answering questions and on other events. For instance, some of the spaces may include indicia of a variety of events that influence the players' progress from a starting point to an ending “finish” point. The player first to navigate the spaces of the game board from the start point to the end point “wins” the game. Although “winning” is an attractive aspect to the game and serves to help engage the players while playing, the learning process realized in playing the game and in preparing custom cards for use in playing the game is enjoyed by all participants.

The game may be designed for all primary and intermediate students and can be played by students of different levels, whereby each student could select a playing card from their area of study at their level or from a set prepared by the student. In this manner, players from different grades and levels can play the game simultaneously and with an added degree of competitive equality.

The present invention provides a structured yet fun way to learn and reinforce core curriculum and provides the additional component of allowing students to create their own playing cards specifically designed for their particular area of study. The present invention provides a study-enhancing academic board game system that educates students in a powerful may by allowing them or their parents or teachers to create game aspects, such as questions, based on actual and particularized curriculum and concepts for each individual student. In this respect, the academic board game system according to the present invention substantially departs from the conventional concepts and designs of the prior art by providing a learning tool, and fun game, directed to the purpose of educating students for their particular and individual areas of study and academic level.

In view of disadvantages inherent in known types of board games, the present invention provides an improved educational study board game system. The new and improved study-enhancing academic board game system and method of the present invention is described hereinbelow in greater detail.

The board game of the present invention provides primary through intermediate students and others for that matter with a fun, informative, engaging, interesting and challenging learning platform. Parents can avoid the problems that arise from children wanting to “play” rather than “study” by allowing them to do both at the same time.

In one embodiment the invention provides an academic board game system for assisting in student education associated with a player curriculum. The system includes: a game board having a plurality of defined spaces that define a path of travel; a plurality of player tokens each representing a player and a player position on the path of travel traversed over the game board during play; a plurality of pre-defined playing cards having associated questions and answers, the pre-defined playing cards being color-coded according to subject matter; and a plurality of custom playing cards on which questions and answers directly related to at least one individual player's curriculum is placed. During play, the custom playing cards are used in part along with the pre-defined playing cards to determine player advancement on the game board. In addition, the inventive system may include one or more of the following features: the custom playing cards may include questions generated by one or more of student, teacher, parent, or school official; the custom playing cards may be generated for common use by a group of students having a common curriculum; during play the custom playing cards and the pre-defined playing cards are randomly selected, and advancement is determined at least in part by player response to the question contained on the card selected; the custom playing cards are color-coded based on subject matter; during play the custom playing cards and the pre-defined playing cards are randomly selected, and the status of a player turn is determined at least in part by player response to the question contained on the card selected; one or both of the custom playing cards and the pre-defined playing cards include questions that are directed to an age-range or a grade level; one or more die that is rolled to determine player movement along the defined path of travel over the game board; one or more intermediate paths along the defined path whereby upon a player token landing upon a particular space associated with the intermediate path the player token is automatically placed at a space other than the landed upon space also associated with the intermediate path; and playing cards that include instructions of at least one of the following types: player act; player draw, player perform; player token movement; and player exchange.

In another embodiment, the present invention provides a method of enhancing student education associated with a player curriculum by playing an academic board game comprising a game board having a plurality of defined spaces that define a path of travel and a plurality of player tokens. The inventive method includes generating a plurality of custom playing cards having questions and answers directly related to at least one individual's curriculum; selecting by a player one of the plurality of custom playing cards; responding by the player to the question contained on the selected custom playing card; and positioning the responding player's token on the game board based at least in part on the response given by the player to the question, whereby on successive player turns a plurality of player tokens are respectively moved along the path of travel traversed over the game board.

### BRIEF DESCRIPTION OF THE DRAWING

A better understanding of the present invention will be had upon reference to the following description in conjunction with the accompanying drawing, wherein:

FIG. 1 shows a game board having spaces thereon in accordance with one embodiment of the present invention.

### DETAILED DESCRIPTION OF THE INVENTION

The game is designed to be played as follows: Each player prepares his/her own playing cards for each subject at their particular school, focusing on concepts that will be the subject of upcoming tests or study. Once the cards are completed, they should be placed in the subject sleeves for storage.

For immediate play, the game includes playing cards that are generic for grade appropriate subjects. In addition, the game is structured that pre-owned or existing flash cards of the player may be used in place of or in addition to the included playing cards or the individually created playing cards. In one embodiment, it is preferred that all playing cards are of a common size, for example standard 3×5 index card size. By using a common, as opposed to proprietary, card configuration, the inventive game system promotes user interaction and facilitates creation and incorporation of user-defined (or school-defined, parent-defined, etc.) cards for play. As described, this helps to tailor the game to a particular set of skills, age level, curriculum, interest, hobby, geography, culture, among other areas of interest.

Beginning Play: Place the game board in the center of the play area.

Place the playing cards (either included or designed by the individual players) in the center of the game board. If players are of different levels, then place each level separately on the center of the game board.

A “Dealer” is selected. This can be a player or another individual that is overseeing the game, such as an adult or parent. When a player lands on “Dealer's Choice,” the role of the “Dealer” is to ask a question, from either the playing cards, a text book, or a secondary source (such as an encyclopedia). The Dealer, if a player, does not advance because of his/her role.

Each player selects a token and places on START. The youngest player goes first. Play then passes to the left. The player whose turn it is rolls one or more die and moves their token or playing piece a number of spaces corresponding to their roll. Upon landing on the space corresponding to the number rolled, the player follows the instructions on the space, if any.

Ending Play: The first player to complete the board, such as by arriving at the end space, point or location, wins the game.

By way of example and not as limitation, the following are exemplary spaces included on the game board. It should be understood that the invention is not limited to this particular configuration and contemplates a variety of configurations of the following game aspects.

“Draw 1 Card”: When a player lands on “Draw 1 Card,” or “pick” or “select”, the player draws, picks or selects a card, such as the top card off the deck of cards, and then answers the question. If the player's answer is correct, the player will be allowed to continue to advance on the board next turn. If the player's answer is incorrect, then the player must remain on the “Draw 1 Card” space until the player answers the question correctly.

“Ask an Opponent”: When a player lands on “Ask an Opponent,” the player draws the top card off the deck and asks the person to their right the question on the card. If the opponent answers the question correctly, the opponent moves ahead the number of spaces rolled on the die. If the opponent's answer is incorrect, the opponent must roll the die to determine how many spaces he/she will move backward. If play is being had by individuals of different levels, the card drawn is selected from that individual's playing card deck.

“Dealer's Choice”: When a player lands on “Dealer's Choice,” the Dealer can choose to ask a question from the playing cards, or from a secondary source, such as a text book or an encyclopedia. If the player's answer is correct, the player will be allowed to continue to advance on the board next turn. If the player's answer is incorrect, then the player must remain on the “Dealer's Choice” space until the player answers the question correctly.

“Wild Card”: When a player lands on “Wild Card,” the player selects whether they will “Draw 1 Card,” “Ask an Opponent,” or “Dealer's Choice.”

If the player decides to select “Draw 1 Card,” then he/she proceeds to follow the “Draw 1 Card” instructions.

If the player decides to select “Ask an Opponent,” then he/she can ask ANY opponent the top card question in their playing card stack, then the opponent proceeds to follow the “Ask an Opponent” instructions.

If the player decides to select “Dealer's Choice,” then he/she proceeds to follow the “Dealer's Choice” instructions.

“Roll Again”: If a player lands on “Role Again” he/she rolls again. In one embodiment, the player then moves the number of spaces corresponding to the number or symbol rolled and proceeds to follow the instructions related to that space.

“Move Forward One Space”: If a player lands on “Move Forward One Space” he/she moves accordingly and proceeds to follow the instructions on that space.

“Move Back One Space”: If a player lands on “Move Back One Space” he/she moves accordingly and proceeds to follow the instructions on that space.

The Broken Heart, the Black Hole: If a player lands on either the “broken heart” or the “black hole” space or area, he/she slides back to the designated spot, thus losing their position on the game board and must comply with the instructions on the space where the player lands.

The White Hole: If a player lands on the “white hole” space or area, then that player or team does not have to answer a question and may remain on that space or in that area. This is in effect a “free space”.

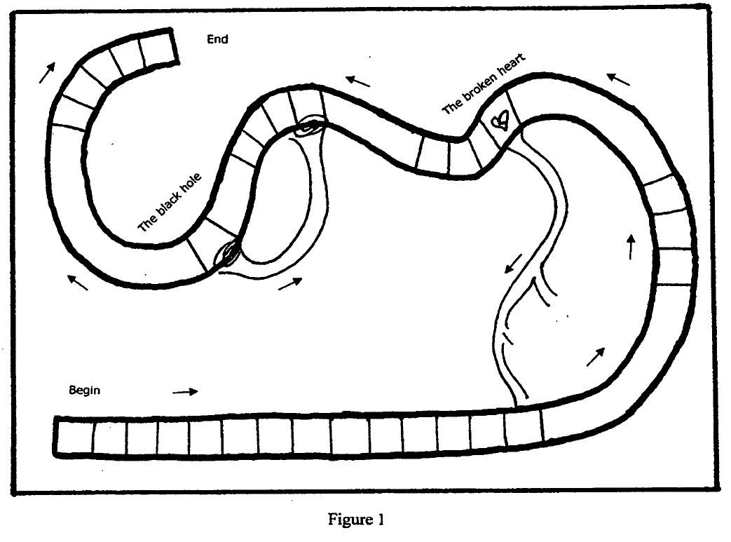

In one embodiment, the present invention provides a study-enhancing academic board game system for assisting in the education and study skills of primary and intermediate students that comprises the following elements. As shown in FIG. 1, an exemplary game board is shown having a plurality of squares that define a path of travel. A plurality of tokens representing each players' position on the path of travel around the game board. A plurality of playing cards or sets of playing cards having questions and answers and that are color-coded to each particular subject, such as Art and Humanities. The playing cards are selected randomly by the players. If a player answers the question correctly they continue to advance. If the player answers the question incorrectly their position on the game board remains the same and their turn ends. A plurality of blank playing cards that may be color-coded as well and on which individual players, teachers, parents or others may write questions and answers particularly specified to one or more individual player's area(s) of study. The personalized or customized playing cards are used in the same manner as the playing cards that accompany the game as may pre-existing cards. The cards are selected randomly by the players and if a player answers the question correctly their turn continues and they may advance, e.g., roll the dice. If the player answers the question incorrectly they remain at their position on the game board and their turn ends. One or more die having a plurality of sides each having indicia related to game play. For example, the indicia may include one or more spots or markings that control the number of squares or spaces to be advanced by a player at the beginning of their turn. In addition, the system includes an information booklet having a plurality of game board rules and instructions.

The present invention is not to be limited in scope by the specific embodiments described herein and is only limited by the appended claims. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

We claim:

1. An academic board game system for assisting in student education associated with a player curriculum, the system comprising:
a game board having a plurality of defined spaces that define a path of travel;
a plurality of player tokens each representing a player and a player position on the path of travel traversed over the game board during play;
a plurality of pre-defined playing cards having associated questions and answers, the pre-defined playing cards being color-coded according to subject matter; and
a plurality of custom playing cards on which questions and answers directly related to at least one individual player's curriculum is placed;
whereby during play, the custom playing cards are used in part along with the pre-defined playing cards to determine player advancement on the game board.

2. The system of claim 1 wherein the custom playing cards include questions generated by one or more of student, teacher, parent, or school official.

3. The system of claim 1 wherein the custom playing cards are generated for common use by a group of students having a common curriculum.

4. The system of claim 1 whereby during play the custom playing cards and the pre-defined playing cards are randomly selected, and advancement is determined at least in part by player response to the question contained on the card selected.

5. The system of claim 1 wherein the custom playing cards are color-coded based on subject matter.

6. The system of claim 1 whereby during play the custom playing cards and the pre-defined playing cards are randomly selected, and the status of a player turn is determined at least in part by player response to the question contained on the card selected.

7. The system of claim 1 wherein one or both of the custom playing cards and the pre-defined playing cards include questions that are directed to an age-range or a grade level.

8. The system of claim 1 further comprising one or more die that is rolled to determine player movement along the defined path of travel over the game board.

9. The system of claim 1 further comprising one or more intermediate paths along the defined path whereby upon a player token landing upon a particular space associated with the intermediate path the player token is automatically placed at a space other than the landed upon space also associated with the intermediate path.

10. The system of claim 1 further comprising playing cards that include instructions of at least one of the following types: player act; player draw, player perform; player token movement; and player exchange.

11. A method of enhancing student education associated with a player curriculum by playing an academic board game comprising a game board having a plurality of defined spaces that define a path of travel and a plurality of player tokens, the method comprising:
generating a plurality of custom playing cards having questions and answers directly related to at least one individual's curriculum;
selecting by a player one of the plurality of custom playing cards;
responding by the player to the question contained on the selected custom playing card; and
positioning the responding player's token on the game board based at least in part on the response given by the player to the question;
whereby on successive player turns a plurality of player tokens are respectively moved along the path of travel traversed over the game board.

12. The method of claim 11 wherein the custom playing cards include questions generated by one or more of student, teacher, parent, or school official.

13. The method of claim 11 wherein the custom playing cards are generated for common use by a group of students having a common curriculum.

14. The method of claim 11 wherein the board game includes a set of pre-defined playing cards and the selecting step includes selecting from among the plurality of custom playing cards and the set of pre-defined playing cards, and advancement is determined at least in part by player response to the question contained on the card selected.

15. The method of claim 11 wherein the custom playing cards are color-coded based on subject matter.

16. The method of claim 11 wherein the plurality of custom playing cards include questions that are directed to an age-range or a grade level.

17. The method of claim 11 wherein the board game includes one or more die that is rolled to determine player movement along the defined path of travel over the game board.

18. The method of claim 11 wherein the game board includes one or more intermediate paths along the defined path whereby upon a player token landing upon a particular space associated with the intermediate path the player token is automatically placed at a space other than the landed upon space also associated with the intermediate path.

19. The method of claim 11 wherein the board game includes playing cards that include instructions of at least one of the following types: player act; player draw, player perform; player token movement; and player exchange.
